(19) United States
(12) Patent Application Publication
(10) Pub. No.: US 2013/0283077 A1
(43) Pub. Date: Oct. 24, 2013

(54) WAKE-UP CIRCUIT AND ELECTRONIC DEVICE

(71) Applicants: HONG FU JIN PRECISION INDUSTRY (SHENZHEN, Shenzhen (CN); HON HAI PRECISION INDUSTRY CO., LTD., New Taipei (TW)

(72) Inventors: XIAO-ZHAN PENG, Shenzhen (CN); QIANG NIE, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/671,612

(22) Filed: Nov. 8, 2012

(30) Foreign Application Priority Data
Apr. 20, 2012 (CN) 201210117451.4

(51) Int. Cl. G06F 1/32

(52) U.S. Cl. 713/323

(57) ABSTRACT

An electronic device includes a power supply, a key module, a signal generating module, a first control module, and a second control module. The key module generates a corresponding pressing signal in response to a pressing operation of a user. The signal generating module is powered by the power supply and generates a wake-up signal in response to the pressing signal. The first control module powered by the power supply. The second control module is being enabled to communicated with the first control module and being disabled and stops communicating with the first control module when the electronic device is in a standby state. The first control module starts to detect whether the wake-up signal is generated when the when the second control module stops communication with the first control module, and controls the second control module to be enabled in response to the wake-up signal.

### BACKGROUND

1. Technical Field

The present disclosure relates to electronic devices, particularly relates to an electronic device with a wake-up circuit.

2. Description of Related Art

Most electronic devices, such as portable computers, include a wake-up circuit for switching from a standby state to a working state by pressing a key. However, sometimes the wake-up key may be stuck in the standby state and the electronic device must be hard-booted to be restarted and the user may lose any temporary or unsaved files when the device is restarted.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an electronic device in accordance with one embodiment.

FIG. 2 is a circuit diagram of the electronic device of FIG. 1 in accordance with one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

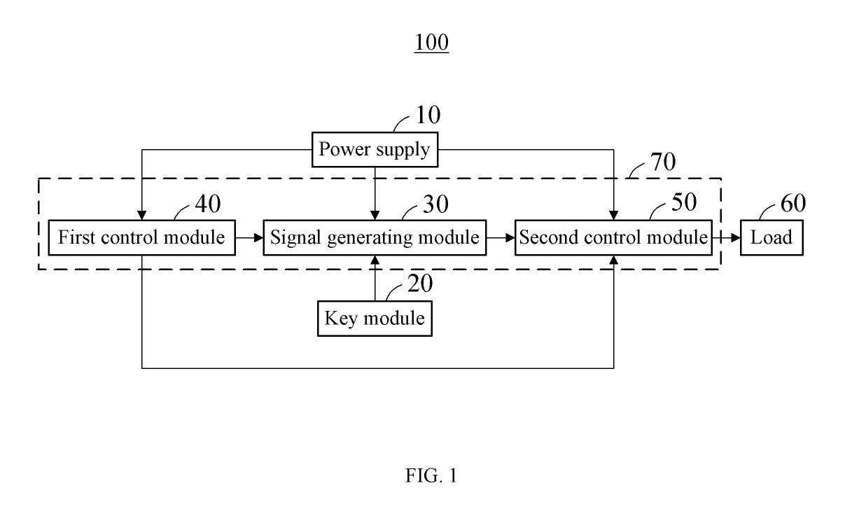

FIG. 1, shows an electronic device 100 of one embodiment of the present disclosure. The electronic device 100 includes a power supply 10, a key module 20, a signal generating module 30, a first control module 40, a second control module 50, and a load 60. The signal generating module 30, the first control module 40, and the second control module 50 forms a wake-up circuit 70 for switching the electronic device 100 from a standby state into a working state. In the embodiment, the electronic device 100 includes a standby function for switching a device such as a DVD player, or a TV for example, from the standby state to the working state.

The power supply 10 provides a first voltage to the signal generating module 30 and the first control module 40, and provides a second voltage to the second control module 50.

The key module 20 connects to power supply 10 through the signal generating module 30 and generates a corresponding pressing signal in response to the operation of a user.

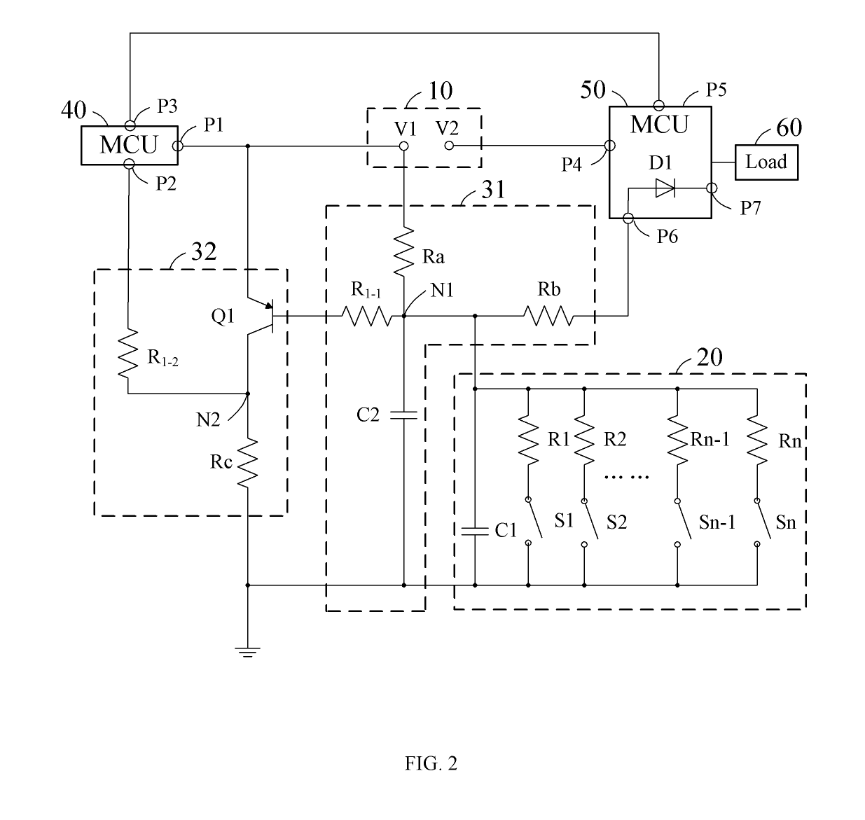

The signal generating module 30 is connected between the power supply 10 and the key module 20. The signal generating module 30 includes a control unit 31 (see FIG. 2) and a switching unit 32 (see FIG. 2). The control unit 31 is electrically connected to the power supply 10 and the key module 20. The control unit 31 generates a first control signal and a key signal in response to the pressing signal, and generates a second control signal without receiving the pressing signal. In the embodiment, the first control signal is a logic low level signal and the key signal and the second control signal are logic high level signals.

The switching module 32 is electrically connected to the power supply 10 and the first control module 40. The switching module 32 is turned on and generates a wake-up signal in response to the first control signal, and is turned off and stops generating the wake-up signal in response to the second control signal. In the embodiment, the wake-up signal is a logic high level signal.

The first control module 40 respectively connects with the power supply 10, the control unit 31 (see FIG. 2), and the second control module 50. The first control module 40 is powered by the voltage of the power supply 10. The first control module 40 further detects the wake-up signal when the second control module 50 is disabled and controls the second module 50 to be enabled in response to the detected wake-up signal.

The second control module 50 respectively connects with the power supply 10, the signal generating module 30, and the first control module 40. The second control module 50 is disabled and stops communicating with the first control module 40 when the electronic device 100 is in the standby state. The second control module 50 is being enabled and communicates with the first control module 40 for transmitting data. The second control module 50 further detects the key signal generated by the control unit 31 to control the load 60 to execute a corresponding function according to the key signal.

The load 60 connects with the second control module 50 and executes a corresponding function according to the pressing signal, such as a playing music function or a playing video function, for example.

Referring to FIG. 2, the power supply 10 includes a first power terminal V1 and a second power terminal V2.

The key module 20 includes a first capacitor C1, a plurality of switches S1-Sn, and a plurality of pull-down resistors R1-Rn. The resistances of the pull-down resistors R1-Rn are different from each other. An end of the first capacitor C1 is electrically connected to the signal generating module 30, and the other end of the first capacitor C1 is grounded. The switches S1-Sn and the pull-down resistors R1-Rn are in a one-to-one relationship. An end of the each switch S1-Sn is grounded, and the other end of the each switches S1-Sn is electrically connected to the node N1 through the corresponding pull-down resistors R1-Rn.

The control unit 31 includes a first resistor Ra, a second resistor Rb, a first protecting resistor R₁₋₁, a first node N1, and a second capacitor C2. An end of the first resistor Ra is electrically connected to the first power terminal V1, and the other end of the first resistor Rb is grounded through the first node N1 the second capacitor C2 in that order. An end of the second resistor Rb is electrically connected to the first node N1, and the other end of the second resistor Rb is electrically connected to the second control module 50. An end of the first protecting resistor R₁₋₁ is electrically connected to the first node N1, and the other end of the first protecting resistor R₁₋₁ is electrically connected to the first control module 40. In the embodiment, the resistance of the second resistor Rb is ten times larger than the resistance of the first resistor Ra and the resistance of any of the pull-down resistors R1-Rn; the resistance of the first protecting resistor R₁₋₁ is equal to the second resistor Rb.

The switching module 32 includes a transistor Q1, a second protecting resistor R₁₋₂, a third resistor Rc, and a second node N2. A base of the transistor Q1 is electrically connected to the third resistor Rc, a collector of the transistor Q1 is grounded through the second node N2 and the second protecting resistor R₁₋₂, an emitter of the transistor Q1 is electrically connected to the first power terminal V1. In the embodiment, the transistor Q1 is a pnp type bipolar junction transistor.

The first control module 40 includes a first pin P1, a second pin P2, and a third pin P3. The first pin P1 is electrically connected to the first power terminal V1. The second pin P2 is electrically connected to the second node N2 through the second protecting resistor R₁₋₂. The third pin P3 is electrically connected to the second control module 50. In the embodiment, the first control module 40 is a micro control unit (MCU, hereinafter).

The second control module 50 includes a fourth pin P4, a fifth pin P5, a sixth pin P6, and a seventh pin P7. The fourth pin P4 is electrically connected to the second power terminal V2. The fifth pin P5 is electrically connected to the third pin P3. The sixth pin P6 is electrically connected to the second resistor Rb. The seventh pin P7 is grounded. In the embodiment, the second control module 50 is a MUC.

When the electronic device 100 is in a standby state and none of the switches S1-Sn is pressed, the second control module 50 is disabled and stops detecting the voltage at the first node N1 and stop communicating with the first control module 40. The sixth pin P6 is in a logic low level by the diode D1 of the second control module 50 and is disabled to detect the voltage at the first node N1. The resistance of the second resistor Rb is ten times larger than the resistance of the second resistor Ra, thus the voltage at first node N1 is equal to the voltage of the first power terminal V1. The difference in voltage between the base and the emitter of the transistor Q1 is equal to or greater than 0V, the transistor Q1 turns off and the voltage at the second node N2 is almost 0V.

When the electronic device 100 is in a standby state and any of the switches S1-Sn is pressed, the voltage at first node N1 is pulled down and the difference in voltage between the base and the emitter of the transistor Q1 is smaller than 0V, the transistor Q1 turns on. The first resistor Ra, the first protecting resistor R₁₋₁, the transistor Q1, and the third resistor Rc form a discharging path from the first terminal V1 to ground. The voltage at the second node N2 is pulled up and equal to the voltage across the third resistor Rc. The voltage at the second node N2 is detected by the second pin P2, and the first control module 40 controls the second control module 50 to be enabled through the third pin P3 and the fifth pin P5, thus the second control module 50 communicates with the first control module 40. The second control module 50 further detects the voltage at the first node N1 through the sixth pin P6 to control the load 60 to execute a corresponding function.

As described, the first MCU is able to control the second MCU to be enabled with the second control module 50 having an internal diode connected between the detecting pin and ground. Therefore, the electronic device 100 is unlikely to be stuck in the standby state.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An electronic device, comprising:
a power supply;
a key module adapted to generate a pressing signal in response to a pressing operation of an user;
a signal generating module powered by the power supply and adapted to generate a wake-up signal in response to the pressing signal;
a first control module powered by the power supply; and
a second control module adapted to being enable to communicate with the first control module and being disabled when the electronic device is in a standby state and stop communicating with the first control module;
wherein the first control module detects whether the wake-up signal is generated when the second control module stops communication with the first control module; when the wake-up signal is generated, the first control module controls the second control module to be enabled and communicating with the first control module in response to the wake-up signal.

2. The electronic device of claim 1, further comprising a load connected to the second control module, wherein the signal generating module further generates a key signal in response to the pressing signal; when the second control module is enabled by the first control module based on the wake-up signal, the second control module detects the key signal and controls the load to perform a corresponding function in response to the detected key signal.

3. The electronic device of claim 1, wherein the signal generating module comprises a control unit and a switch unit, the control unit is connected to the power supply and the key module, the switch unit is connected to the power supply and the first control module, the control unit generates a first control signal in response to the pressing signal, the switch unit is turned on according to the first control signal to generate the wake-up signal; the control unit generates a second control signal when the key module stops generating the pressing signal, the switch unit is turned off according to the second control signal to stop generating the wake-up signal.

4. The electronic device of claim 3, wherein the control unit further generates the key signal in response to the pressing signal and outputs the key signal to the second control module.

5. The electronic device of claim 3, wherein the control unit comprises a first resistor, a second resistor, and a capacitor; an end of the first resistor is electrically connected to the power supply, and the other end of the first resistor is grounded through the capacitor; an end of the second resistor is electrically connected between the first resistor and the capacitor, and the other end of the second resistor is electrically connected to the second control module.

6. The electronic device of claim 5, wherein the resistance of the second resistor is ten times larger than the resistance of the first resistor.

7. The electronic device of claim 3, wherein the switching unit comprises a transistor, and a third resistor; a base of the transistor is electrically connected to the control unit, an emitter of the transistor is electrically connected to the power supply, a collector of the transistor is grounded through the third resistor.

8. The electronic device of claim 6, wherein the transistor is a pnp type bipolar junction transistor.

9. The electronic device of claim 5, wherein the key module comprises a second capacitor, a plurality of switches, and a plurality of pull-down resistors; an end of the first capacitor is electrically connected to the signal generating module and the other end of the first capacitor is grounded; the switches and the pull-down resistors are in a one-to-one relationship; an end of each switches is grounded, and the other end of each switches is electrically connected to the signal generating module through the corresponding pull-down resistors.

10. The electronic device of claim 9, wherein the resistances of the pull-down resistors R1-Rn are different from each other, and each resistance of the pull-down resistors is smaller than the resistance of the second resistor.

11. A wake-up circuit connected to a power supply and a key module adapted to generate a pressing signal in response to a user's operation; the wake-up circuit comprising:
a signal generating module powered by the power supply and adapted to generate a wake-up signal in response to the pressing signal;
a first control module powered by the power supply; and
a second control module adapted to being enable to communicate with the first control module and being disabled and stop communicating with the first control module;
wherein the first control module detects whether the wake-up signal is generated when the second control module stops communication with the first control module; when the wake-up signal is generated, the first control module controls the second control module to be enabled and communicating with the first control module.

12. The wake-up circuit of claim 11, wherein the wake-up circuit is further connected to a load; the signal generating module further generates a key signal in response to the pressing signal; when the second control module is enabled by the first control module based on the wake-up signal, the second control module detects the key signal and controls the load to perform a corresponding function in response to the detected key signal.

13. The wake-up circuit of claim 11, wherein the signal generating module comprises a control unit and a switch unit, the control unit is connected to the power supply, the switch unit is connected to the power supply and the first control module, the control unit generates a first control signal in response to the pressing signal, the switch unit is turned on according to the first control signal to generate the wake-up signal; the control unit generates a second control signal when the key module stops generating the pressing signal, the switch unit is turned off according to the second control signal to stop generating the wake-up signal.

14. The wake-up circuit of claim 13, wherein the control unit further generates the key signal in response to the pressing signal and outputs the key signal to the second control module.

15. The wake-up circuit of the claim 13, wherein the control unit comprises a first resistor, a second resistor, and a capacitor; an end of the first resistor is electrically connected to the power supply, and the other end of the first resistor is grounded through the capacitor; an end of the second resistor is electrically connected between the first resistor and the capacitor, and the other end of the second resistor is electrically connected to the second control module.

16. The wake-up circuit of claim 15, wherein the resistance of the second resistor is ten times larger than the resistance of the first resistor.

17. The wake-up circuit of claim 13, wherein the switching unit comprises a transistor and a third resistor; a base of the transistor is electrically connected to the control unit, an emitter of the transistor is electrically connected to the power supply, a collector of the transistor is grounded through the third resistor.

18. The wake-up circuit of claim 17, wherein the transistor is a pnp type bipolar junction transistor.
